(19) United States
(12) Patent Application Publication
(10) Pub. No.: US 2010/0304075 A1
(43) Pub. Date: Dec. 2, 2010

(54) ENHANCED EXPANDED POLYSTYRENE FOAM INSULATION

(75) Inventors: Grazyna Petela, Calgary (CA); Michel Berghmans, Calgary (CA); Thomas Chee, Calgary (CA)

Correspondence Address: NOVA Chemicals Inc./Karen S. Lockhart, 1555 Coraopolis Heights Road, Moon Township, PA, 15108, US

(73) Assignee: NOVA CHEMICALS INC., Moon Township, PA (US)

(21) Appl. No.: 12/473,527

(22) Filed: May 28, 2009

(51) Int. Cl. B32B 3/26; B32B 27/30; B29C 44/24

(52) U.S. Cl. 428/71; 428/407; 428/304.4; 428/319.3; 428/319.1; 264/48

(57) ABSTRACT

Partially expanded closed-cell unmatured polystyrene bead with a partial vacuum within the cells inside the bead, which may be coated with an air impervious coating to retain a partial vacuum inside cells for a prolonged period of time. The resulting bead has improved thermal insulating properties and may be used for insulation.

### FIELD OF THE INVENTION

The present invention relates to polymeric insulating material. More particularly the present invention relates to an un-aged or partially aged hollow partially expanded closed-cell polymeric bead having an internal pressure less than 600 millibars. Such beads individually have a lower thermal conduction than comparable beads which have been aged and in which air has diffused into the bead cells, bringing the pressure within the bead to substantially ambient pressure (atmospheric pressure). The beads may be coated with an air impervious layer to prevent air diffusion into their interior and used as loose fill insulation or be molded into insulating sheets or boards which have external surfaces coated against air penetration.

### BACKGROUND OF THE INVENTION

Fiber bats, typically glass fiber, have been used as thermal insulation for a number of years.

Sheets of polymeric foam have also been used for thermal insulation for a number of years. The foam may have been open or closed celled and may have contained reflective material such as carbon black to increase the thermal insulation.

Silica (silicon dioxide) aerogels are also known, and these materials provide extremely high insulating (“R”) values.

All the above insulation types have air, at ambient pressure, filling the spaces between fibers (bats) or in their cells (EPS, aerogels).

Different type of insulation are vacuum foams and they are taught by e.g. U.S. Pat. No. 5,674,916 issued Oct. 7, 1997 to Shmidt et al., assigned to The Dow Chemical Company; U.S. Pat. No. 5,977,197 issued Nov. 2, 1999 to Malone also assigned to The Dow Chemical Company; and U.S. Pat. No. 7,166,348 issued Jan. 23, 2007 to Naito et al. assigned to JSP Corporation. The principle of vacuum insulating material is that a sheet of extruded open cell foam is subject to a vacuum and then sealed with an air impermeable sheet which may also be metalized to reflect heat. The vacuum insulation is effective provided the vacuum is maintained. These are expensive materials, because the manufacturing process requires the step of evacuating the open celled foamed sheet and applying the external sealing surface. There are concerns about maintaining the integrity of the external sealing surface, particularly over extended periods of time.

There are also known vacuum insulated panels in which a core containing micro-pores such as open cell polystyrene, polyurethane, and nano-porous materials such as fumed silica, titania or carbon, are pressed into a rigid sheet, evacuated and sealed with an air tight barrier.

Spherical evacuated beads, with a partial vacuum in their interior, are known as well. For example, evacuated glass microspheres are commercially available from Trelleborg Emerson & Cuming. Inc., under the trade mark Eccospheres®. Unfortunately, many of these newer materials are expensive when used in specific, highly demanding industrial and commercial applications and are not widely used in commercial, packaging or construction applications. There is a need for a durable, lower cost, highly insulating material which would be suitable for wide applications in, e.g., residential construction.

The present invention seeks to provide foamed bead having a partial vacuum in closed cells, which was created without any specially arranged processing steps, procedure or equipment. The beads can be foamed and molded into sheets or blocks, which are then sealed against air diffusion into cells with an air-impermeable coating or sheet. The foamed beads can also be sealed individually against air diffusion with an air-impermeable coating and used as loose fill insulation.

### SUMMARY OF THE INVENTION

The present invention provides an un-aged or partially aged polymeric bead which has been expanded from 20 to 50 times their initial bead size, having after the expansion an internal pressure in closed interior cells (i.e., cells inside the bead) at levels less than 600 millibars, and which have been:
i) either coated with an air impervious layer having a thickness from 3 to 200 microns, to prevent bead aging; or
ii) molded into a block or sheet or slab, which has at least one, preferably all, external surfaces subsequently enveloped (e.g., coated or a sheet covering) with an air impervious layer to prevent air diffusion into cells of the molded beads.

In a further embodiment, the present invention provides a process to make beads as described above, comprising preparing suspension polymerized expandable polymer beads, expanding them to 20 to 50 times their original size and, before they are matured, molding the beads into blocks and sealing the external block surfaces with an air impervious layer (e.g., either coating or film or a combination thereof).

### BRIEF DESCRIPTION OF THE DRAWINGS

FIG. 1 is a schematic diagram of the apparatus used in Example 1 to test the thermal insulating properties of various blocks of expandable polystyrene foam and a foam block of the present invention.

FIG. 2 is a plot of the thermocouple readings from Example 1.

FIG. 3 is a plot of thermal curves or profiles of Example 1 for the EPS Silver, which is EPS with added reflective particles of carbon black in amount of ˜8 wt %, the Vacuum EPS and the Matured Vacuum EPS after the vacuum was lost.

FIG. 4 is a plot of the thermal profiles inside the EPS Silver, the aged and un-aged Vacuum EPS.

### DETAILED DESCRIPTION OF THE INVENTION

Closed cell polymeric foams may be prepared from polymer beads polymerized via suspension process. The polymeric beads are formed typically in the presence of a peroxide initiator from a vinyl aromatic compound and, optionally, with one or more of copolymers and elastomeric modifiers to form a poly vinyl aromatic compound, such as polystyrene, which may be modified, optionally, with an elastomer (e.g. rubber) to form high impact polystyrene.

The vinyl aromatic polymer may be selected from the group consisting of:
(i) homopolymers or copolymers of one or more monomers selected from the group consisting of C₆₋₈ vinyl aromatic monomers which are unsubstituted or may be substituted by one or more members selected from the group consisting of a halogen atom, preferably chlorine and C₁₋₄ alkyl radicals; and
(ii) copolymers comprising from 95 to 60, preferably from 95 to 75, most preferably from 95 to 85 weight % of one or monomers selected from the group consisting of C₆₋₈ vinyl aromatic monomers which are unsubstituted or may be substituted by one or more members selected from the group consisting of a halogen atom, preferably chlorine and C₁₋₄ alkyl radicals; and from 5 to 40, preferably from 5 to 25, most preferably from 5 to 15 weight % of one or more monomers selected from the group consisting of C₁₋₈, preferably C₁₋₄ alkyl esters of C₃₋₅ ethylenically unsaturated mono or di-carboxylic acids; and C₂₋₃ alkenyl nitriles.

Some C₆₋₈ vinyl aromatic monomers include styrene, methyl styrene, typically, para-methylstyrene, and alpha methyl styrene, chlorostyrene and bromostyrene.

Some alkenyl nitriles include acrylonitrile and methacrylonitrile.

Some C₁₋₈, alkyl esters of C₃₋₅ ethylenically unsaturated mono or di-carboxylic acids include methyl methacrylate, ethyl methacrylate, methyl acrylate, and ethyl acrylate.

When finally polymerized, the bead polymers should have a number average molecular weight greater than 65,000 preferably greater than 70,000.

The polymer forming the bead may include from about 5 to 40 weight % of an elastomer (e.g., rubber) to form high impact polymer such as high impact polystyrene (HIPS).

The elastomers may be selected from the group comprising:
i) co- or homo-polymers of one or more C₄₋₆ conjugated diolefin monomers which are unsubstituted or substituted by a halogen atom, preferably, chlorine;
ii) random, block or star polymers comprising:
   (a) from 30 to 70, preferably 40 to 60 weight % of one or more vinyl aromatic monomers which are unsubstituted or may be substituted by one or more members selected from the group consisting of a halogen atom, preferably chlorine and C₁₋₄ alkyl radicals; and
   (b) from 70 to 30, preferably 60 to 40 weight % of one or more C₄₋₆ conjugated diolefins which may be unsubstituted or substituted by a halogen atom, preferably, chlorine; and
iii) random, block or star polymers comprising:
   (a) from 95 to 60, preferably 95 to 75, weight % of one or more C₄₋₆ conjugated diolefins which may be unsubstituted or substituted by a halogen atom, preferably chlorine; and
   (b) from 5 to 40, preferably 5 to 25, weight % of one or more C₂₋₃ alkenyl nitriles.

The elastomers (rubbers) which may be used as impact modifiers in the present invention will typically have a (weight average) molecular weight (Mw) of greater than about 100,000, preferably greater than 200,000. Block rubber copolymers have significantly lower molecular weight, typically greater than 50,000 (Mw). It should be kept in mind that the rubber should be soluble in one or more of the monomers of the bead polymer. Typically, from about 1 to 20, preferably from about 3 to 12, most preferably from 4 to 10 weight % of the rubber is dissolved in the monomer or a mixture of monomers to form a “syrupy” solution which is then polymerized. The solubility of the above rubbers in various monomers may be easily determined by non-inventive routine testing.

Preferably, the elastomer (rubber) is co- or homo-polymer of one or more C₄₋₆ conjugated diolefins (e.g., butadiene). Generally, such co- or homo-polymers have a level of stereospecificity. The selection of the degree of stereospecificity will depend to some extent upon the properties required in the final product. Some polybutadienes contain over 90, most preferably over 95 weight % of monomer in the cis configuration. However, the polybutadiene may contain a lower amount, typically, from 50 to 65, most preferably, about 50 to 60 weight % of monomer in the cis configuration.

As noted above, beads are prepared using a suspension polymerization. Preferably, the polymerization reactor maintains a low shear flow in the polymerizing suspension to maintain both the suspension particle size and also the particle size of the dispersed rubber phase if present. Such a low-shear reactor is disclosed in a number of patents and applications in the name of Petela including Canadian patents and applications 2,606,144; 2,504,395; 2,433,063; 2,433,053; and 2,433,046, the entire specifications of which are hereby incorporated by reference.

The polymerizing bead is impregnated with a blowing agent. The blowing agent, typically, a C₄₋₆ alkane, such as pentane, is included in the suspension mixture and diffuses and dissolves into the bead during the polymerization stage which is called the impregnation process. In an alternate suspension process, the bead is first prepared, fully polymerized and then impregnated with the blowing agent.

The beads are removed from the suspension reactor, dried, and partially expanded (pre-expanded) under action of steam. During the expansion process, beads are softening due to exposure to steam, while liquid impregnation agent (blowing agent),which had been absorbed by beads, rapidly evaporates, increases its volume causing bead expansion and, finally, escapes from beads. At this stage, beads increased their volumes typically 20-50 times of their initial size. They still contain some traces of blowing agent in cells, but the pressure in the cells is much lower than atmospheric level and can be termed as a “partial vacuum”. This partial vacuum should be below 600 millibars (0.6 atm or 60.8 kPa), preferably below 500 millibars (0.5 atm or 50.7 kPa) desirably below 300 millibars (0.3 atm or 30.4 kPa), most desirably below 200 millibars (0.2 atm or 20.3 kPa). The lower limit for the partial vacuum will be the crush strength of the expanded bead. Beads are fragile and vulnerable in this state and if they are deformed they cannot regain their shape. In a conventional process, beads are next left exposed to air, typically, for a period from 24 hrs to 3 days. During this period, which is called “bead aging”, air diffuses into the bead until the internal pressure in bead cells increases to substantially atmospheric level.

However, in accordance with one embodiment of the present invention, the partially expanded bead is not allowed to “mature” but, just after pre-expansion, is coated with an air impervious layer. In this specification, “air impervious layer” means that the major gas components in air (e.g., oxygen, carbon dioxide and nitrogen) will not pass through the layer. Some of the other components in air, which have trace concentrations, including argon, neon, helium, methane, krypton, nitrous oxide, hydrogen, xenon, and ozone may diffuse through the impervious layer, but preferably not. The coated pre-expanded loose beads can be used as loose fill insulating material. The coated pre-expanded beads may also be molded into a sheet, slab or block and used in that form or optionally further at least partially covered with a radiation reflective material (e.g., metalized Mylar and/or a vapor barrier (e.g., a polyolefin film).

In a further embodiment of the present invention, the pre-expanded beads, which have not matured and remain uncoated, are molded into a foam block, sheet or slab, by applying heat and pressure. The resulting closed cell foam block sheet or slab is quickly enveloped with an air impervious coating or layer (liquid coating, sheet or film, e.g., reflective Mylar and/or a vapor barrier), to prevent air from diffusing into the cells of the mold. The molded sheet, slab or block can be used as an insulating material.

The air impervious coating may have a thickness from 3 to 200 micrometers (μm-microns), typically, from 5 to 50 um, preferably, from 10 to 25 um. The coating may be applied by any suitable process such as spraying or immersion of the beads or by spraying or immersion of the molded sheet, slab or block. It could be arranged that both the beads and the resulting sheet, slab or block are enveloped (e.g., either coated or wrapped in a foil such as metalized PET) to improve the durability of the block, sheet or slab as it may (will likely) be subject to surface abrasion or puncture during use at a construction site.

The air impervious layer can be selected from the group consisting of:
i) polyvinylidene chloride;
ii) polymers comprising from 80 to 95, preferably from 90 to 95 weight % of vinylidene chloride and 20 to 5 preferably from 10 to 5 weight %, of one or more monomers selected from the group consisting of one or more C₁₋₆, preferably C₁₋₄ alkyl esters, of a C₃₋₆ carboxylic acid, preferably acrylic or methacrylic acid, acrylonitrile and optionally from 0 to 15 weight % of vinyl chloride;
iii) poly (p-xylylene);
iv) latex of synthetic or natural rubber; and
v) crosslinked aliphatic polyesters.

The polymers may have an intrinsic viscosity of at least 0.45 dL/g, typically from about 0.60 to 1.0 dL/g.

The polyvinylidene chloride polymers, or the copolymers of vinylidene chloride, may be formed into a dispersion using conventional diluents. Typically, the dispersion will contain about 50 weight % or more of the polymer. The continuous phase should not dissolve the bead polymer. Water may be a particularly suitable diluent; however, simple non-inventive experiments can be used to determine if the solvent or diluents will dissolve the polymer bead (e.g., apply the solvent or diluents to the bead and see if it impairs the bead in about 24 hrs).

The latex of natural rubber is essentially a latex of polyisoprene (e.g., 93-95 weight % cis 1,4-poly-isoprene).

Synthetic latex is produced by the emulsion polymerization, typically, a free radical emulsion polymerization, of from 100 to 30, preferably from 70 to 30, most preferably from 60 to 40 weight %, of one or more C₄₋₅ conjugated diolefins which may be unsubstituted or substituted by a halogen atom, preferably chlorine; and from 30 to 70, preferably from 40 to 60 weight %, of one or more monomers selected from the group consisting of:
(i) C₆₋₈ vinyl aromatic monomers which are unsubstituted or may be substituted one or more members selected from the group consisting of a halogen atom, preferably chlorine and C₁₋₄ alkyl radicals;
(ii) C₂₋₃ alkenyl nitriles; and optionally
(iii) from 0 to 40, preferably 5 to 35, typically from 5 to 10 weight %, of one or more monomers selected from the group consisting of C₃₋₅ ethylenically unsaturated mono or di-carboxylic acids or anhydrides, amides and C₁₋₈, preferably C₁₋₄, alkyl and alkanol esters thereof thereof; and C₂₋₃ alkenyl nitriles.

Some C₆₋₈ vinyl aromatic monomers include styrene, methyl styrene, typically, para methylstyrene and alpha methylstyrene, chlorostyrene and bromostyrene.

Alkenyl nitriles include acrylonitrile and methacrylonitrile.

Carboxylic acids and anhydrides include acrylic acid, methacrylic acid, maleic acid, and itaconic acid and C₁₋₄ alkyl esters thereof (e.g., methyl, ethyl, propyl and butyl) and anhydrides thereof such as maleic anhydride and amides thereof such as acrylamide, and methacrylamide.

The latex may have a solid content from about 50 to about 70 weight %.

Some commercially available latices include polychloroprene (e.g., neoprene), styrene-butadiene latices which may be functionalized, typically, with a carboxylic acid, and butadiene acrylonitrile latices.

Water based systems may require further drying than organic based systems and as such organic based systems may be preferred over water based systems.

Crosslinked aliphatic polyesters may comprise a C₂₋₆ alkylene glycol dimmers, trimers, tetramers and low molecular weight polymers thereof having a molecular weight not greater than about 1500, preferably less than 600, and esters thereof with C₃₋₅ ethylenically unsaturated carboxylic acid. Typically, alkylene glycols include polyethylene glycol and polypropylene glycol. Derivatives include ethylene glycol dimethacrylate, ethylene glycol diacrylate, diethylene glycol diacrylate, diethylene glycol dimethylacrylate, triethylene glycol diacrylate, triethylene glycol dimethylacrylate, tetraethylene glycol diacrylate, tetraethylene glycol dimethacrylate, polyethylene glycol (Mw<600) diacrylate, polyethylene glycol (Mw<600) dimethacrylate, propylene glycol diacrylate, propylene glycol dimethacrylate, dipropylene glycol diacrylate, dipropylene glycol dimethacrylate, tripropylene glycol diacrylate, tripropylene glycol dimethacrylate, tetrapropylene glycol diacrylate, tetrapropylene glycol dimethacrylate, dimethylol propane tetraacrylate, trimethylol propane tetraacrylate, trimethylol propane trimethylacrylate, trimethylolpropane triacrylate, 1,3-butylene glycerol dimethacrylate, 1,3-butylenes glycerol diacrylate, 1,4-butanediol dimethacrylate, 1,4-butanediol diacrylate, 1,6-hexanediol dimethacrylate, 1,6-hexanediol diacrylate.

The above crosslinkable compounds may be crosslinked with radiation (x-ray, etc.) but it is preferable to crosslink them using UV radiation in the presence of photo-initiators in a dispersion or solution of the compounds. The photo-initiator may be present in the solution or dispersion in small amounts, typically, less than 0.1 weight % (10,000 ppm) preferably less than 0.01 weight % (1,000 ppm). Some photo-initiators include α,α-dimethyl-α-hydroxylacetophenone, 1-(1-hydroxycyclohexyl)-phenyl methanone (1-hydroxycyclohexyl phenyl ketone), benzoin methyl ether, benzoin ethyl ether, benzoin isobutyl ether, α,α-dimethoxy-α-phenyl acetophenone, α,α-diethoxy acetophenone, 1-phenyl-1,2-propanedione, 2-(O-benzoyl) oxime, diphenyl(2,4,6-trimethyl benzoyl)phosphine, α-dimethylamino-α-ethyl-α-benzyl-3,5-dimethyl-4-morpholinoacetophenone. Care needs to be used in the selection and amount of the photo-initiator with the crosslinkable aliphatic ethers.

The un-matured beads, sheets, slabs or blocks of the un-matured beads may be coated with a solution or dispersion of the crosslinkable aliphatic polyesters and exposed to a suitable energy source to complete the crosslinking of the polyester.

For some applications, particularly for use in insulation where termites or other insects may be a problem, it may de desirable to incorporate insecticides into the bead per se or into the air impervious coating. The insecticide may be incorporated into the bead polymer by dissolving it in the monomers prior to or during polymerization. The insecticides might also be incorporated into air impervious coating for the bead. The insecticide may be used in amounts to provide from 100 to 10,000 parts per million (ppm) based on the total weight of the coated bead (e.g., polymer and coating).

The insecticides may be selected from the group consisting of borates, 1-[(6-chloro-3-pyridinyl)methyl]-4,5-dihydro-N-nitro-1H-imidazol-2-amine; 3-(2,2-dichloroethenyl)-2,2-di-methylcyclopropanecarboxylic acid; cyano(3-phenoxyphenyl)-methyl ester; 3-(2,2-dichloroethenyl)-2,2-dimethylcyclopropanecarboxylic acid (3-phenoxyphenyl)methyl ester; and 1-[(6-chloro-3-pyridinyl)methyl]-4,5-dihydro-N-nitro-1H-imidazol-2-amine (imidacloprid).

Suitable borates include salts or esters of boron. In particular, disodium octaborate tetrahydrate (Na₂B₈O₁₃ 4H₂O) which may have a typical chemical analysis of sodium oxide (Na₂O) 14.7%; boric oxide (B₂O₃) 67.1%; and water of crystallization (H₂O) 18.2%. The disodium octaborate tetrahydrate may comprise 99.4% of the total chemical content of the treatment chemical with impurities and other inert ingredients comprising the remaining 0.6% of the treatment chemical. The minimum borate oxide (B₂O₃) content of the treatment chemical should be in a range from about 50% to about 70%, with the optimal proportion being about 66.1%.

As the beads, sheet, slab or block are intended to be used in construction it is also desirable that the beads, sheets, slabs or blocks comprise a flame retardant. The flame retardant may be incorporated into the beads or the air-impervious coating to provide from 5,000 ppm to 50,000 ppm based on the weight of the polymer of a flame retardant. The flame retardant may be selected from the group consisting of hexabromocyclododecane, dibromoethyidibromocyclohexane, tetrabromocyclooctane, tribromophenol alkyl ether, tetrabromobisphenol A-bis(2,3-dibromopropyl ether) and mixtures thereof.

The flame retardant may be added to the monomer mixture prior to or during polymerization or may be added to the coating.

The beads, sheets, slabs or blocks of the present invention are believed to reduce conductive heat loss; however, it may also be desirable to reduce reflective heat loss. Accordingly, the beads, sheets, slabs or blocks may further comprise from about 1 to 25 weight % of an infrared attenuating agent selected from the group consisting of carbon black, furnace black, acetylene black, channel black, graphite, and ceramic or glass microspheres having a vacuum therein.

The sheets, slabs or blocks may also include additional elements such as expanded vermiculite and long glass fibers (e.g., having a length greater than about 2 inches, typically, from about 2.5 inches or greater (e.g., up to about 6 or 8 inches) which may be incorporated in amounts from about 5 to 60 weight % based on the final weight of the sheet, slab or block. Additionally, the expanded partially vacuumed beads, being formed into a sheet, slab or block, could also contain small amounts of “getter” compounds that adsorb gas if it should enter the vacuum and desiccants. Typically, such materials would be used in small amounts from about 1 to 10, preferably from 1 to 8, most preferably from about 2 to 6 weight % of the bead, sheet, slab or block.

In a further embodiment, the sheets, slabs or blocks of the present invention may be wrapped in or have a covering on one surface of one or more layers. The sheets, slabs or blocks could be wrapped in or have a surface covering of a polyolefin sheet such as polyethylene or polypropylene to provide a vapor barrier, and/or may be wrapped in or have a surface covering of a cardboard, paper, non woven fibers such as TYVEK® (a non woven polyolefin sheet), polyester sheet such as polyethylene terephthalate (PET) or polybutylene terephthalate (PBT) optionally having a metalized surface (e.g., aluminum) or an aluminum foil per se, to provide an IR reflective surface while also enhancing the integrity of the vacuum in the sheets, slabs or blocks.

The sheets, slabs or blocks, which are to be applied as thermal insulation for the building construction industry, are preferably sized to friction fit between the supports for walls, roofs and floors. They may be held in place by an adhesive or may be fixed by a mechanical means such as staples, particularly if there is a covering on the sheets, slabs or blocks that extends beyond the side of the sheet, slab or block.

In a further embodiment, the loose beads, with the additional additives noted above, could be coated with an air impervious material and poured into appropriate envelopes made of the above materials with or without a reflective (metalized) surface and the filled envelope could be used as insulation.

In a further embodiment, the loose partially vacuumed beads, with the additional additives noted above, could be encapsulated in a binding and sealing medium, rather than coating the beads with an air impervious material or molding the beads into a sheet, slab or block and coating the external surfaces.

The present invention will now be illustrated by the following non limiting examples.

### EXAMPLES

### Example 1

Three types of foam samples were prepared for examination of their insulating properties. The first type were blocks with dimensions of 1.5″×2″×4″, which were molded from beads of regular expanded polystyrene (EPS) which had “matured”. The second type were blocks of expandable polystyrene which had been pre-expanded to two different densities, dried for 10-20 min. in a fluidized bed and molded into foam blocks with dimensions of 1.5″×2″×4″. These blocks had partial vacuum in cells, which was created due to the escape of a large part (>90%) of pentane from the bead cells during the pre-expansion and molding processes. Both of these processes were completed within <1 hr., so atmospheric air did not diffuse yet into foam cells to compensate for a lost pentane pressure. The foam blocks with a partial vacuum in cells were next “vacuum packed” to preserve the vacuum in their cells and to prevent air from diffusing into their interiors. To vacuum pack the samples, a FoodSaver Vacuum Packaging System (V2840-CN) was used, which is a small kitchen appliance for vacuum packaging of perishable food, for household use only. The packing process was very simple: a foam block (Vacuum EPS) was wrapped in a polyethylene envelope (which included 4 polyethylene layers and one layer of nylon), air was evacuated from the envelope and next the envelope was air-tightly sealed. The third type of samples were blocks of regular expandable polystyrene, which incorporated about 6-8 weight % of carbon black (and was available under the trade mark SILVER™ from NOVA Chemicals (International) S.A.) as an infrared reflector and the blocks had a silver appearance.

All of the samples had the same dimensions and two sets of each sample type were produced with two different densities.

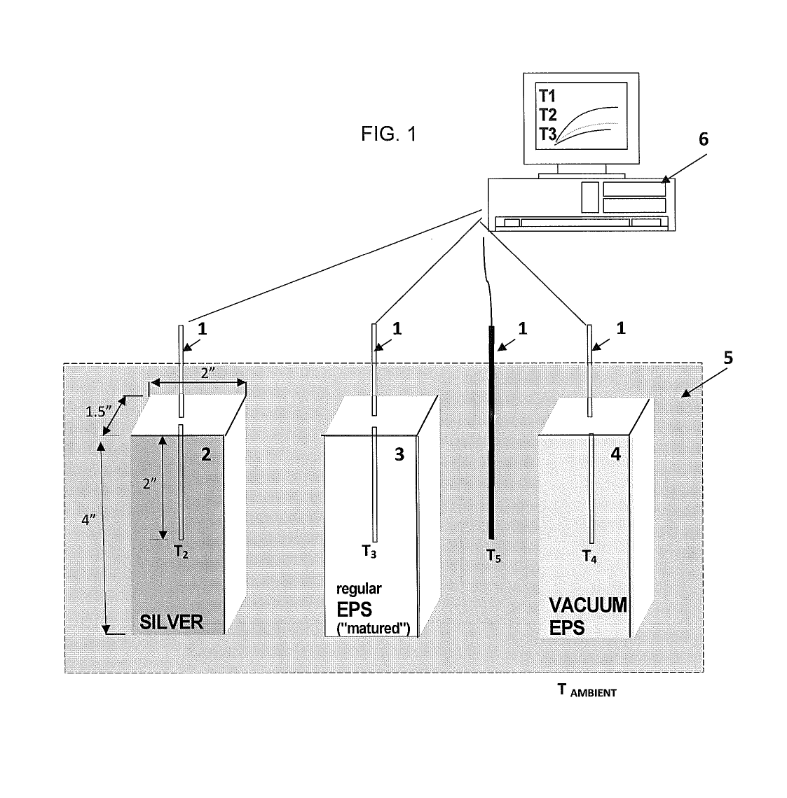

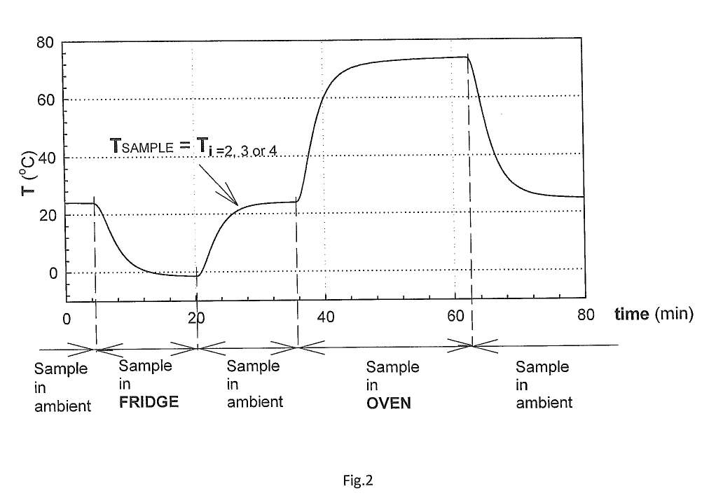

The following experiment was carried out to compare, on a qualitative basis, the insulating properties of SILVER, EPS and Vacuumed EPS using the experimental setup which is schematically shown in FIG. 1. The set of 3 samples comprising regular EPS with carbon black “SILVER”, regular EPS and Vacuumed EPS, all with the same density, was selected. The sealing polyethylene envelope had been removed from the Vacuum EPS sample. It was recognized that after removing the sealing layer air would start slowly to diffuse into the closed cells in the foam block; however, it was believed this would be sufficiently slow to conduct the experiments. Three thermocouples (1) were inserted inside each of the foam samples: Silver (2), regular matured EPS (3) and Vacuumed EPS (4) in such a way that the temperature measuring tips were in the middle of the respective foam samples. The samples were taken from the lab environment (i.e., they were at ambient temperature) and placed in a heating or cooling enclosure (5), either a refrigerator which maintained a constant temperature from the range of 0° C. to −10° C. or an oven which had maintained a constant temperature of ˜70° C. As the foam samples started to be cooled or heated in the enclosure, the temperature changes inside each of the samples were measured by the inserted thermocouples and monitored in time by a computer (6). The example of temperature changes recorded as a function of time by the thermocouple inside a foam sample which was placed first in the cooling and, next, in the heating enclosures, is shown in FIG. 2. The rate at which the temperature was changing inside each of the samples with time, from an initial ambient level to the temperature levels matching temperatures in the interiors of the refrigerator or the oven, was dependent on the sample insulating properties. The sample with the best insulating properties (i.e., with the lowest overall heat transfer coefficient) would show the slowest temperature change in its interior, while the sample with the worst insulating properties (with the highest overall heat transfer coefficient) would have the fastest changes of its temperature and will be the first one to reach the temperature levels which prevailed in the refrigerator or in the oven.

The results were analyzed, on a comparison basis, from two perspectives:
Firstly, whether the method is sufficiently sensitive to detect any differences in temperature changes between these three samples at all, and
Secondly, if the experimental method was sufficiently sensitive to capture the temperature differences between interiors of the SILVER and the regular EPS samples, after they were placed in a cooling environment inside the refrigerator or in a heating environment inside the oven. These temperature differences would result from the fact that SILVER was a better insulator and its overall heat transfer coefficient was 4%-7% lower than the respective coefficient of the regular EPS. Therefore, any temperature changes inside the SILVER sample should be slightly slower than the respective temperature changes inside the regular EPS sample. If the method could capture these temperature differences resulting from 4%-7% differences in heat transfer coefficients between the SILVER and EPS samples, this result could be used as a reference to evaluate a possible difference (if any) between heat transfer coefficients of the regular EPS and the Vacuumed EPS samples.

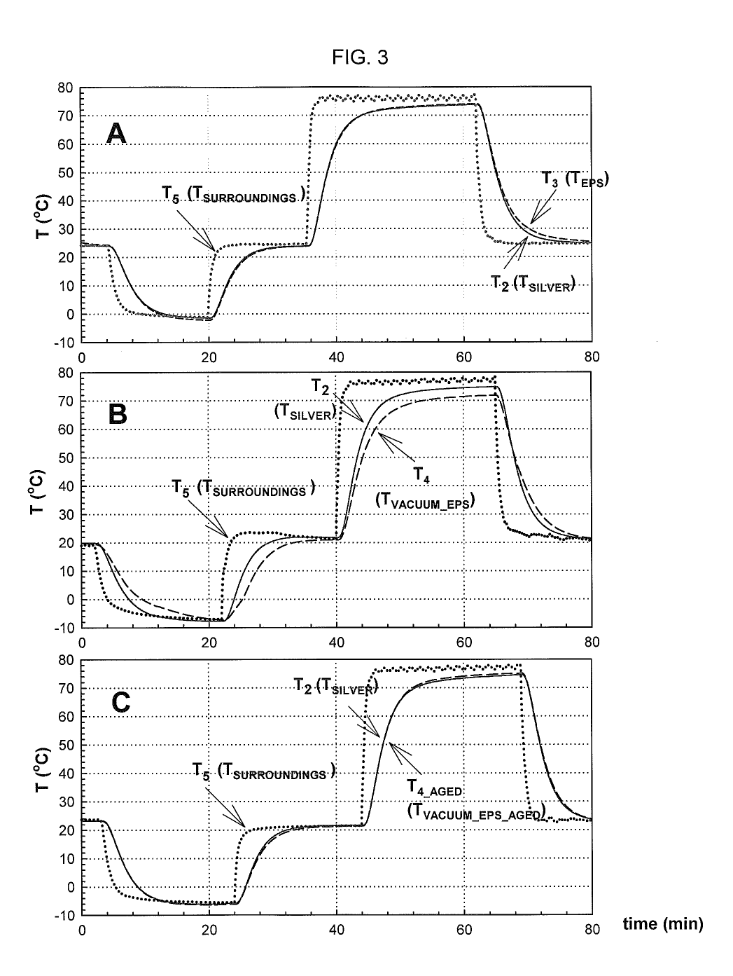

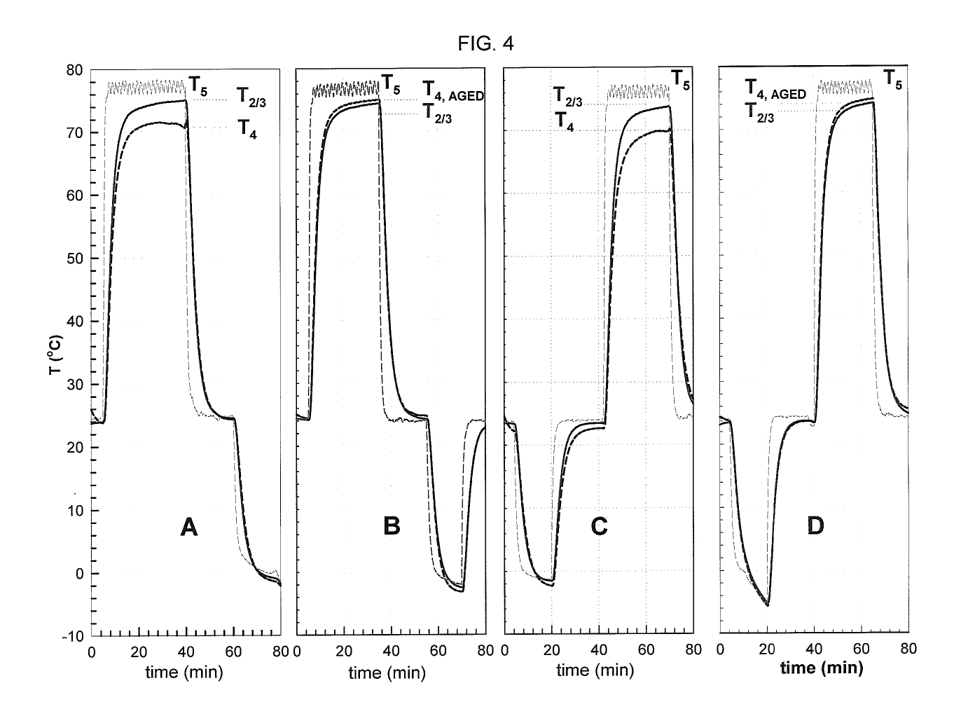

The experiments were repeated with over 30 Vacuumed EPS samples, analyzed and compared with SILVER and regular EPS, leading to the following observations:
The experimental method was not sensitive enough to detect a difference in insulating properties between SILVER and regular EPS and temperature changes were identical at any time inside both these samples after they were transferred from ambient and placed either in the oven or in the refrigerator, as shown in FIG. 3A.
Temperature changes inside the Vacuum EPS sample were noticeably slower and lower by ˜4-5° C. than in the other two samples, as shown in FIG. 3B, indicating that the vacuum EPS has better insulating properties than both the regular EPS and SILVER.
The Vacuumed EPS sample, which had matured for several days and had cells filled with air, when it was subjected again to the same experiment, showed identical temperature changes as SILVER and as the regular EPS, as shown in FIG. 3C.
These trends were repeatable for different temperature ranges in heating and cooling environments (oven and freezer) for the sets of Vacuumed EPS, regular EPS and SILVER samples with two respective densities. The examples of temperature changes in two other Vacuumed EPS blocks, as compared to SILVER, after both samples were placed in oven and refrigerator are shown in FIG. 4A and 4C.

Over the course of the experiments, the vacuum in the “Vacuumed EPS” was lost. The experiment was repeated and temperature curves or profiles were generated for the EPS Silver, the Vacuumed EPS and the Matured vacuum EPS after the vacuum was lost, as shown in FIGS. 4B and 4D. The results show that the Vacuumed EPS has significantly better insulating properties than regular EPS and SILVER, i.e., EPS with incorporated infrared reflector. The very approximate calculations, based on the recorded temperature changes, indicated that Vacuumed EPS can have an overall heat transfer coefficient higher by 30-60% than the regular EPS insulation.

### Example 2

Expandable polystyrene beads were suspension polymerized and air dried as in Example 1. The unmatured beads where then molded into a block. The block was then spray coated with a solution/dispersion of polyethylene glycol diacrylate (25-30 wt. %), acrylic acid oligomers (3-5 wt %), trimethyloltriacrylate (0-1 wt %) ethylene glycol diacrylate (0-1 wt %) and a very small amount of 1-hydroxycyclohexyl phenyl ketone in a solvent/diluent which did not degrade the polystyrene obtained from Chemcraft® International Inc. under the product name E11-0044 100% UV spray. The resulting block had good integrity and retained its vacuum.

What is claimed is:

1. An un-aged or partially aged polymeric bead with internal closed cells which has been expanded from 10 to 50 times the size of the unexpanded bead, having an internal pressure in the cells less than 600 millibars, which has been coated with an air impervious layer having a thickness from 3 to 200 microns.

2. The bead according to claim 1, wherein the polymer in the polymeric bead is selected from the group consisting of:
(i) homopolymers or copolymers of one or more monomers selected from the group consisting of C₆₋₈ vinyl aromatic monomers which are unsubstituted or may be substituted by one or more members selected from the group consisting of a halogen atom, preferably chlorine and C₁₋₄ alkyl radicals; and
(ii) copolymers comprising from 95 to 60, weight % of one or more monomers selected from the group consisting of C₆₋₈ vinyl aromatic monomers which are unsubstituted or may be substituted by one or more members selected from the group consisting of a halogen atom, preferably chlorine and C₁₋₄ alkyl radicals and from 5 to 40 weight % of one or more monomers selected from the group consisting of C₁₋₈, preferably C₁₋₄, alkyl esters of C₃₋₅ ethylenically unsaturated mono or di-carboxylic acids and C₂₋₃ alkenyl nitriles which polymers may further comprise from 5 to 40 weight % of one or more elastomers.

3. The polymeric bead according to claim 2 wherein the polymer further comprises from 5 to 40 weight % of one or more elastomers selected from the group consisting of:
(i) co- or homo-polymers of one or more C₄₋₆ conjugated diolefin monomers which are unsubstituted or substituted by a halogen atom, preferably chlorine;
(ii) random, block or star polymers comprising:
(a) from 30 to 70, preferably 40 to 60 weight % of one or more vinyl aromatic monomers which are unsubstituted or may be substituted by one or more members selected from the group consisting of a halogen atom, preferably chlorine and C₁₋₄ alkyl radicals;
(b) from 70 to 30, preferably 60 to 40 weight % of one or more C₄₋₆ conjugated diolefins which may be unsubstituted or substituted by a halogen atom, preferably chlorine; and
(iii) random, block or star polymers comprising:
(a) from 95 to 60, preferably 95 to 75, weight % of one or more C₄₋₆ conjugated diolefins which may be unsubstituted or substituted by a halogen atom, preferably chlorine; and
(b) from 5 to 40, preferably 5 to 25, weight % of one or more C₂₋₃ alkenyl nitriles.

4. The bead according to claim 2, wherein the air impervious layer is selected from the group consisting of:
(i) polyvinylidene chloride;
(ii) polymers comprising from 80 to 95 weight % of vinylidene chloride and 20 to 5 weight % of one or more monomers selected from the group consisting of one or more C₁₋₆, preferably esters of a C₃₋₆ carboxylic acid, acrylonitrile and optionally from 0 to 15 weight % of vinyl chloride;
(iii) poly (p-xylylene);
(iv) a latex of synthetic or natural rubber; and
(v) crosslinked aliphatic polyesters.

5. The bead according to claim 4, further comprising from 100 to 10,000 parts per million (ppm) based on the total weight of the coated bead of an insecticide selected from the group consisting of borates, 1-[(6-chloro-3-pyridinyl)methyl]-4,5-dihydro-N-nitro-1H-imidazol-2-amine; 3-(2,2-dichloroethenyl)-2,2-di-methylcyclopropanecarboxylic acid; cyano(3-phenoxyphenyl)-methyl ester; 3-(2,2-dichloroethenyl)-2,2-dimethylcyclopropanecarboxylic acid (3-phenoxyphenyl)methyl ester; and 1-[(6-chloro-3-pyridinyl)methyl]-4,5-dihydro-N-nitro-1H-imidazol-2-amine(imidacloprid).

6. The bead according to claim 4, further comprising a flame retardant in an amount from 5,000 ppm to 50,000 ppm based on the weight of the polymer of a flame retardant selected from the group consisting of hexabromocyclododecane, dibromoethyldibromocyclohexane, tetrabromocyclooctane, tribromophenol alkyl ether, tetrabromobisphenol A-bis(2,3-dibromopropyl ether) and mixtures thereof.

7. The bead according to claim 4, further comprising from about 1 to 25 weight % of an infrared attenuating agent selected from the group consisting of carbon black, furnace black, acetylene black, channel black, graphite and ceramic microspheres having a vacuum therein.

8. A molded sheet, slab or block comprising the beads of claim 2.

9. A molded sheet, slab or block according to claim 8, further comprising on at least a major surface one or more of a vapor barrier and metallic foil having reflective surface facing external to said sheet.

10. The molded sheet, slab or block according to claim 9, wherein the vapor barrier comprises a sheet of a polyolefin.

11. The molded sheet, slab or block according to claim 9, wherein the metallic foil is selected from the group consisting of aluminum foil and a polyester foil having a metallic surface.

12. The molded sheet, slab or block according to claim 9, wherein the matrix further comprises one or more members selected from the group consisting of glass microspheres, expanded vermiculite and long glass fibers.

13. A sheet, slab or block molded of un-aged or partially aged polymeric beads which have been expanded from 10 to 50 times the size of the unexpanded bead, having internal closed cells and internal pressure in the cells less than 600 millibars and the said sheet, slab or block has been coated on all surfaces with an air impervious layer having a thickness from 3 to 200 microns.

14. A molded sheet, slab or block according to claim 13, further comprising on at least a major surface one or more of a vapor barrier and metallic foil having reflective surface facing external to said sheet.

15. The molded sheet, slab or block according to claim 14, wherein the vapor barrier comprises a sheet of a polyolefin.

16. The molded sheet, slab or block according to claim 14, wherein the metallic foil is selected from the group consisting of aluminum foil and a polyester foil having a metallic surface.

17. The molded sheet, slab or block according to claim 14 wherein the matrix further comprises one or more members selected from the group consisting of glass microspheres, ceramic microspheres, expanded vermiculite and glass fibers.

18. A process to make a bead according to claim 2 comprising preparing a suspension polymerized expandable polymer bead and expanding it to 20 to 50 times its size, and before it is matured coating the surface of the bead with an air impervious layer having a thickness from 3 to 200 microns.

19. The process according to claim 18, wherein the polymer is selected from the group consisting of:
(i) homopolymers or copolymers of one or more monomers selected from the group consisting of C₆₋₈ vinyl aromatic monomers which are unsubstituted or may be substituted by one or more members selected from the group consisting of a halogen atom, preferably chlorine and C₁₋₄ alkyl radicals; and
(ii) copolymers comprising from 95 to 60 weight % of one or monomers selected from the group consisting of C₆₋₈ vinyl aromatic monomers which are unsubstituted or may be substituted by one or more members selected from the group consisting of a halogen atom, preferably chlorine and C₁₋₄ alkyl radicals and from 5 to 40 weight % of one or more monomers selected from the group consisting of C₁₋₈, preferably C₁₋₄, alkyl esters of C₃₋₅ ethylenically unsaturated mono or di-carboxylic acids and C₂₋₃ alkenyl nitrites which polymers may further comprise from 5 to 40 weight % of one or more elastomers.

20. The process according to claim 19 wherein the air impervious layer is elected from the group consisting of:
(i) polyvinylidene chloride;
(ii) polymers comprising from 80 to 95 weight % of vinylidene chloride and 20 to 5 weight % of one or more monomers selected from the group consisting of one or more C₁₋₆, preferably esters of a C₃₋₆ carboxylic acid, acrylonitrile and optionally from 0 to 15 weight % of vinyl chloride;
(iii) poly (p-xylylene);
(iv) a latex of synthetic or natural rubber; and
(v) crosslinked aliphatic polyesters.

21. The process according to claim 20, wherein the polymer beads are spray coated with a solution or dispersion of material forming said impervious layer.

22. The process according to claim 20, wherein said beads are immersed in a solution or dispersion of material forming said impervious layer.
